(19) United States
(12) Patent Application Publication
(10) Pub. No.: US 2024/0272893 A1
(43) Pub. Date: Aug. 15, 2024

(54) VERSION COMPATIBILITY METADATA TRANSFORMATION

(71) Applicant: VMWARE, INC., Palo Alto, CA (US)

(72) Inventors: VRUSHANK UPADHYAY, Rajkot (IN); MAKARAND RAMESH GAWADE, Pune (IN)

(21) Appl. No.: 18/109,875

(22) Filed: Feb. 15, 2023

(51) Int. Cl. G06F 8/65; G06F 16/25

(52) U.S. Cl. CPC G06F 8/65; G06F 16/258

(57) ABSTRACT

An example method may include obtaining, at a first instance, first compatibility metadata associated with a product from a webserver, wherein the compatibility metadata includes an indication of compatibility or incompatibility between a plurality of versions associated with the product in a first format. Further, the method may include transforming, using a data structure, the compatibility metadata from the first format to a second format and storing the transformed compatibility metadata on a local datastore. The second format may indicate a list of candidate upgrade versions that are compatible with a current version of the product. Furthermore, the method may include rendering the stored compatibility metadata including the list of candidate upgrade versions that are compatible with the current version of the product on a user interface of a client device in response to receiving an upgrade request.

### TECHNICAL FIELD

The present disclosure relates to computing environments, and more particularly to methods, techniques, and systems for transforming version compatibility metadata in a computing environment.

### BACKGROUND

Today, some software products, including upgrades, may be distributed over the Internet. When a user desired to change versions of a software product, the user can browse to a vendor's website, download a new version of software, and install the new version on the computer. To fetch available upgrade versions, the user may have to manually browse through all available versions provided by vendor's website (e.g., download.vmware.com) and find if the version is compatible for upgrade every time.

### BRIEF DESCRIPTION OF THE DRAWINGS

FIG. 1 is a block diagram of an example system, depicting an upgrade recommendation module to transform compatibility metadata from a first format to a second format using a data structure;

FIG. 2 is a flow diagram illustrating an example method for rendering a list of candidate upgrade versions that are compatible with a current version of a product on a user interface;

FIG. 3 is a sequence diagram illustrating an example sequence of events to retrieve compatibility metadata and build a data structure with the retrieved compatibility metadata; and

FIG. 4 is a block diagram of an example management node including non-transitory computer-readable storage medium storing instructions to populate a data structure indicating a list of candidate upgrade versions that are compatible with each current version of a product.

The drawings described herein are for illustrative purposes and are not intended to limit the scope of the present subject matter in any way.

### DETAILED DESCRIPTION

Examples described herein may provide an enhanced computer-based and/or network-based method, technique, and system to transform version compatibility metadata in a computing environment. The paragraphs [0009] and [0010] present an overview of the computing environment, existing methods to check version compatibility for software upgrade, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products.

In such computing environments, the software product including upgrades may be distributed over the Internet. When a user desired to change versions of the software product, the user can browse to a vendor's website, download a new version of software, and install the new version on the computer. To fetch available upgrade versions, the user may have to manually browse through all available versions provided by vendor's website (e.g., download.vmware.com) and find if the version is compatible for upgrade every time. In such existing methods, the user may have to download a compatibility matrix associated with an upgrade version from the website and then check whether a current version of the product is present in the list of compatible versions provided in the compatibility matrix, which can be time consuming. When there are a significant number of releases to go through, manually browsing through all available versions can cause the application programming interface (API) to lag and hence the process of checking the compatibility becomes slow. In some existing methods, the compatibility matrix is embedded or bundled in the upgrade package. In such existing methods, the compatibility matrix is provided as part of the upgrade package and hence altering of the compatibility matrix may not be allowed.

Examples described herein may provide a management node including an upgrade recommendation module to execute a scheduled command (e.g., a cron job) to obtain first compatibility metadata associated with a product from a webserver. The compatibility metadata may include an indication of compatibility or incompatibility between a plurality of versions associated with the product in a first format. Further, the upgrade recommendation module may transform, using a data structure, the compatibility metadata from the first format to a second format. The second format may indicate a list of candidate upgrade versions that are compatible with a current version of the product. Furthermore, the upgrade recommendation module may store the transformed compatibility metadata on a local datastore. In response to receiving a request to upgrade the product, the upgrade recommendation module may render the stored compatibility metadata including the list of candidate upgrade versions that are compatible with the current version of the product on a user interface of a client device.

Thus, examples described herein may reduce or eliminate the downtime as there are no external API calls involved when a current version (e.g., “from version”) is matched with the transformed compatibility metadata in the local datastore. In this case, the list of candidate upgrade versions associated with the current version is retrieved from the local datastore and returned to the user. Since the data structure is maintained locally, the transformed compatibility metadata can be altered to reflect any changes associated with the compatibility metadata in the webserver.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

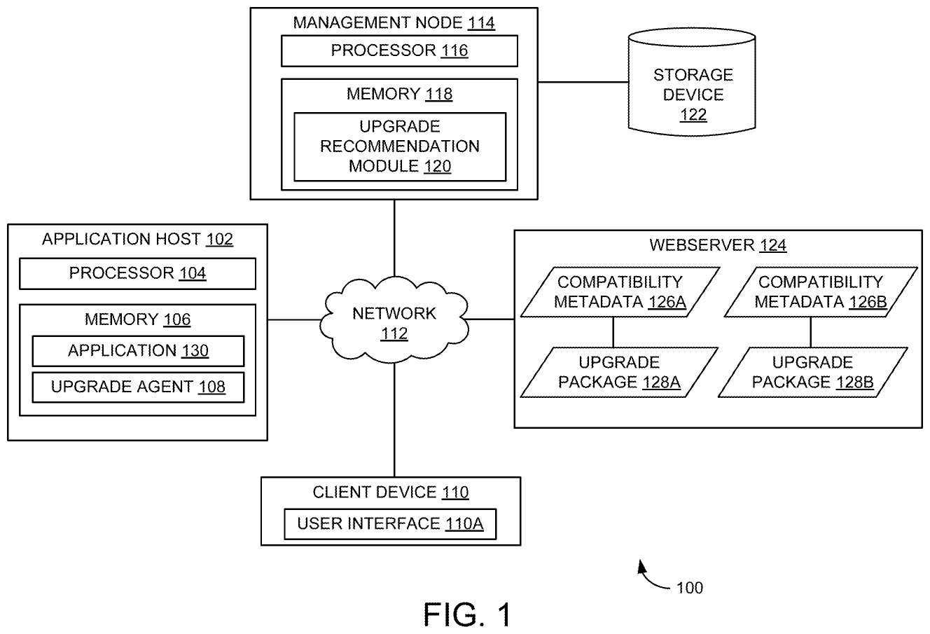

Referring now to the figures, FIG. 1 is a block diagram of an example system 100, depicting an upgrade recommendation module 120 to transform compatibility metadata from a first format to a second format using a data structure. Example system 100 may be a cloud computing environment. For example, the cloud computing environment may be enabled by vSphere®, VMware's cloud computing virtualization platform. Further, system 100 may include multiple data centers. A data center may be a physical data center (e.g., an on-premises enterprise computing environment) and/or a virtual data center (e.g., a cloud computing environment, a virtualized environment, or the like). For example, the physical data center may include one or more physical host computing devices (e.g., servers), each of which may be configured to execute one or more applications. In another example, a number of virtual data centers may be deployed within the physical data center using virtual machines. The virtual data center may be a pool or collection of cloud infrastructure resources designed for enterprise needs. Furthermore, the virtual data center may be a virtual representation of the physical data center, complete with servers, storage clusters and networking components, all of which may reside in a virtual space being hosted by one or more physical data centers.

Further, system 100 may include a plurality of application hosts (e.g., an application host 102). For example, application host 102 may include physical host computing devices, virtual machines, containers, or any combination thereof. A physical host computing device may be a hardware-based device (e.g., a personal computer, a laptop, and the like) including an operating system (OS). The virtual machine may operate with its own guest OS on the physical host computing device using resources of the physical computer virtualized by virtualization software (e.g., a hypervisor, a virtual machine monitor, and the like). Containers can run on a host operating system without a hypervisor or separate operating system, such as a container that runs within Linux. A container can be provided by a virtual machine that includes a container virtualization layer (e.g., Docker).

Further, application host 102 may include a processor 104 and memory 106 coupled to processor 104. Further, application host 102 may execute at least one application (e.g., application 130) and an upgrade agent 108. An example application, also referred to as an application program or application software, may be a software package or product that performs a specific function directly for an end user or, in some cases, for another application. An example application may include a distributed computing system (also referred to as a distributed software system). The distributed computing system may refer to a construct which involves various infrastructure parties that act together to enable a business service. For example, the distributed computing system includes components that are located on different networked computers, which communicate and coordinate their actions by passing messages to one another. An example application may include a server virtualization application (e.g., vSphere of VMware®), a storage virtualization application (e.g., vSAN of VMware®), a network virtualization and security application (e.g., NSX of VMware®), and the like. In other examples, the applications may include MySQL, Tomcat, Apache, word processors, database programs, web browsers, development tools, image editors, communication platforms, and the like.

Furthermore, system 100 includes a management node 114 in communication with application host 102 via a network 112. Example network 112 can be a managed Internet protocol (IP) network administered by a service provider. For example, network 112 is implemented using wireless protocols and technologies, such as WiFi, WiMax, and the like. In other examples, network 112 can also be a packet-switched network such as a local area network, wide area network, metropolitan area network, Internet network, or other similar type of network environment. In yet other examples, network 112 is a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 114 includes a processor 116 and a memory 118 coupled to processor 116. The term “processor” may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. The processor may, for example, include single or multiple cores on a chip, multiple cores across multiple chips, multiple cores across multiple devices, or suitable combinations thereof. The processor may be functional to fetch, decode, and execute instructions as described herein.

In other examples, management node 114 may be implemented as software program running on a physical computer or a virtual computer. Example management node 114 may be a VMware® vCenter™ server with at least some of the features available for such server. Memory 118 may include upgrade recommendation module 120. During operation, upgrade recommendation module 120 may execute a command, at a first instance, to obtain first compatibility metadata (e.g., compatibility metadata 126A and 126B) associated with a product (e.g., application 130) from a webserver 124. An example command may be a cron job, a program to automate a scheduled task at a defined time.

In an example, upgrade recommendation module 120 may execute the command to transmit a hypertext transfer protocol (HTTP) get command to webserver 124. Further, upgrade recommendation module 120 may receive a response to the HTTP get command from webserver 124. The response may include the first compatibility metadata (e.g., compatibility metadata 126A and 126B). The first compatibility metadata may provide information indicating a list of current versions that are compatible with each candidate upgrade version of a plurality of candidate upgrade versions of the product.

In some examples, the first compatibility metadata includes a plurality of upgrade compatibility matrices corresponding to a plurality of candidate upgrade versions. Each upgrade compatibility matrix may provide information of versions from which the product can be upgraded to a particular candidate upgrade version of the plurality of candidate upgrade versions. An example first compatibility metadata may include a first format {to version: [from version]}. An example first format for the first compatibility metadata is shown below:
For candidate upgrade version 4.0.1.0.0, compatible from version list is: 3.0.0.0.0, 3.1.0.0.0, 3.2.0.0.0.
For candidate upgrade version 4.1.0.0.0, compatible from version list is: 3.0.0.0.0, 3.1.0.0.0, 3.2.0.0.0, 4.0.1.0.0.

In some examples, upgrade recommendation module 120 may execute the command to transmit a first HTTP get command to webserver 124 and receive a first response to the first HTTP get command from webserver 124. The first response may include the list of candidate upgrade versions (e.g., 4.0.1.0.0 and 4.1.0.0.0). For each candidate upgrade version in the list of candidate upgrade versions (e.g., 4.0.1.0.0 and 4.1.0.0.0), upgrade recommendation module 120 may transmit a second HTTP get command to webserver 124 and receive a second response to the second HTTP get command. The second response may include a uniform resource locator (URL) associated with a compatibility matrix of a candidate upgrade version. Further, for each candidate upgrade version in the list of candidate upgrade versions (e.g., 4.0.1.0.0 and 4.1.0.0.0), upgrade recommendation module 120 may download the compatibility matrix (e.g., in the first format) associated with the candidate upgrade version corresponding to the URL.

Further, upgrade recommendation module 120 may parse the first compatibility metadata to determine a list of versions from which the product can be upgraded to each candidate upgrade version. Furthermore, upgrade recommendation module 120 may populate a data structure with the parsed first compatibility metadata. The populated data structure may indicate a list of candidate upgrade versions that are compatible with each current version of the product. An example populated data structure may include a second format {From version: [to version]}. Considering the above example, the second format for the populated data structure is shown below:
{3.0.0.0.0:[4.0.1.0.0, 4.1.0.0.0]},
{3.1.0.0.0:[4.0.1.0.0, 4.1.0.0.0]},
{3.2.0.0.0:[4.0.1.0.0, 4.1.0.0.0]}, and
{4.0.1.0.0:[4.1.0.0.0]}.

In response to receiving an upgrade request, upgrade recommendation module 120 may render the populated data structure on a user interface 110A of a client device 110. In an example, upgrade recommendation module 120 may receive an upgrade request (e.g., an API request) to upgrade the product (e.g., application 130) running in application host 102. The upgrade request may be received from upgrade agent 108 running in application host 102. The upgrade request may be triggered by a user via client device 110. The upgrade request may indicate a current version of the product or include information associated with the current version of the product. In response to receiving the upgrade request, upgrade recommendation module 120 may retrieve a list of candidate upgrade versions that are compatible with the current version of the product from the populated data structure. Then, upgrade recommendation module 120 may render the list of candidate upgrade versions that are compatible with the current version of the product on user interface 110A of client device 110.

Further, upgrade recommendation module 120 may receive a selection of a candidate upgrade version in the list of candidate upgrade versions via user interface 110A. In response to receiving the selection, upgrade recommendation module 120 may download an upgrade package (e.g., upgrade package 128A or 128B) associated with the candidate upgrade version from webserver 124. Furthermore, upgrade recommendation module 120 may upgrade the product (e.g., application 130) based on the upgrade package. In this example, upgrade recommendation module 120 may coordinate with upgrade agent 108 to upgrade the product.

In other examples, upgrade recommendation module 120 may execute the command (e.g., the cron job) at a second instance to obtain second compatibility metadata associated with the product from webserver 124. Further, upgrade recommendation module 120 may analyze the second compatibility metadata to detect a change in the second compatibility metadata compared to the first compatibility metadata. In response to detecting the change in the second compatibility metadata, upgrade recommendation module 120 may update the populated data structure in a local datastore (e.g., a storage device 122) based on the detected change (i.e., to reflect the detected change).

Thus, when the request (e.g., an HTTP request) to upgrade the product is received by the API, upgrade recommendation module 120 may return the populated data structure that is maintained in a local datastore (e.g., on local storage device 122 associated with management node 114) to user interface 110A of client device 100. When a current version of the product indicated by the request is matched with the populated data structure, the list of candidate upgrade versions that are compatible with the current version is retrieved from the local datastore and presented on user interface 110A. Since there are no external API calls involved, the downtime can be reduced. Also, any alteration in the compatibility data can be performed in the local datastore by periodically querying webserver 124.

In some examples, the functionalities described in FIG. 1, in relation to instructions to implement functions of upgrade recommendation module 120, and any additional instructions described herein in relation to the storage medium, may be implemented as engines or modules including any combination of hardware and programming to implement the functionalities of the modules or engines described herein. The functions of upgrade recommendation module 120 may also be implemented by a processor. In examples described herein, the processor may include, for example, one processor or multiple processors included in a single device or distributed across multiple devices.

Further, the cloud computing environment illustrated in FIG. 1 is shown purely for purposes of illustration and is not intended to be in any way inclusive or limiting to the embodiments that are described herein. For example, a typical cloud computing environment would include many more remote servers (e.g., application hosts), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

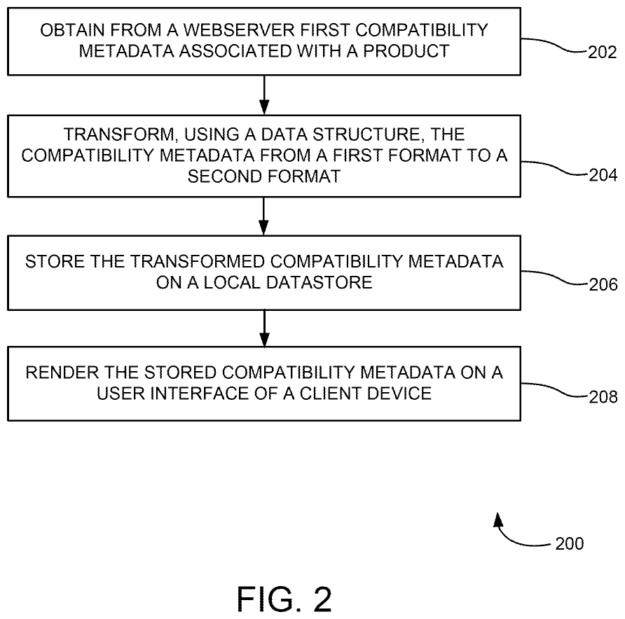

FIG. 2 is a flow diagram illustrating an example method 200 for rendering a list of candidate upgrade versions that are compatible with a current version of a product on a user interface. Example method 200 depicted in FIG. 2 represents generalized illustrations, and other processes may be added, or existing processes may be removed, modified, or rearranged without departing from the scope and spirit of the present application. In addition, method 200 may represent instructions stored on a computer-readable storage medium that, when executed, may cause a processor to respond, to perform actions, to change states, and/or to make decisions. Alternatively, method 200 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 202, first compatibility metadata associated with a product may be obtained from a webserver at a first instance. The compatibility metadata may include an indication of compatibility or incompatibility between a plurality of versions associated with the product in a first format. In an example, a cron job may be executed to obtain the compatibility metadata associated with the product from the webserver.

In an example, obtaining the first compatibility metadata associated with the product may include executing a scheduled command to:
transmit a first hypertext transfer protocol (HTTP) get command to the webserver,
receive a first response to the first HTTP get command from the webserver, the first response including the list of candidate upgrade versions, and
for each candidate upgrade version in the list of candidate upgrade versions:
   transmit a second HTTP get command to the webserver, and
   receive a second response to the second HTTP get command, the second response including the first compatibility metadata associated with the product.

At 204, the compatibility metadata may be transformed from the first format to a second format using a data structure. The second format may indicate a list of candidate upgrade versions that are compatible with a current version of the product. In an example, the first format may include data indicating mapping of a candidate upgrade version with a list of current versions from which the product can be upgraded to the candidate upgrade version. The second format may include data indicating mapping of the current version with a list of candidate upgrade versions to which the product can be upgraded from the current version.

At 206, the transformed compatibility metadata may be stored on a local datastore. In response to receiving an upgrade request, at 208, the stored compatibility metadata including the list of candidate upgrade versions that are compatible with the current version of the product may be rendered on a user interface of a client device. In response to a selection of a candidate upgrade version in the list of candidate upgrade versions, an upgrade package associated with the selected candidate upgrade version may be downloaded from the webserver. Further, the product may be upgraded based on the upgrade package.

Further, second compatibility metadata associated with the product may be obtained from the webserver at a second instance. The second compatibility metadata may be analyzed to detect a change in the second compatibility metadata compared to the first compatibility metadata. In response to detecting the change in the second compatibility metadata, the transformed compatibility metadata may be updated in the local datastore based on the detected change.

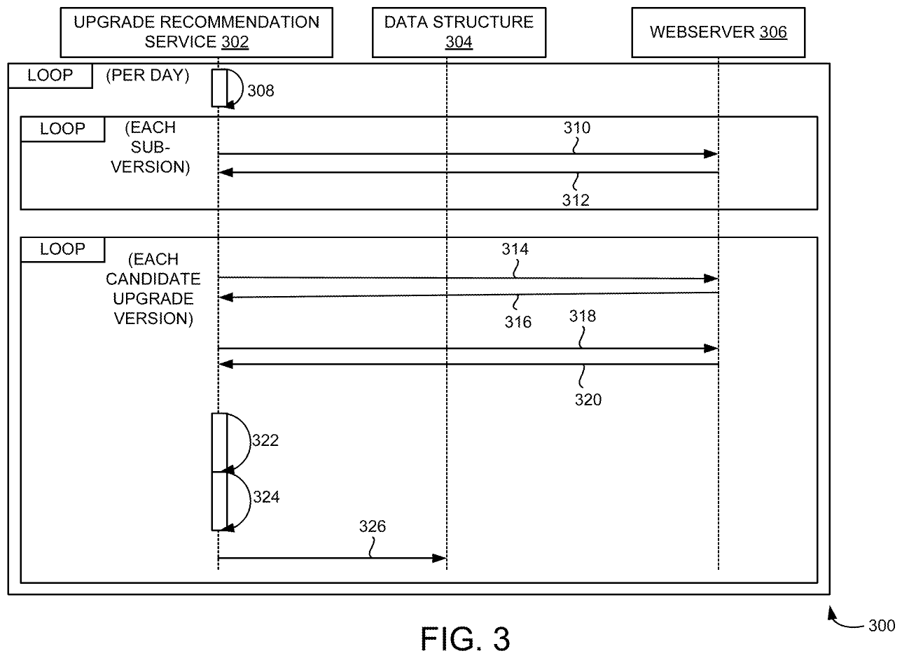

FIG. 3 is a sequence diagram 300 illustrating an example sequence of events to retrieve compatibility metadata and build a data structure with the retrieved compatibility metadata. Sequence diagram 300 may represent the interactions and the operations involved in building the data structure that indicates a list of candidate upgrade versions that are compatible with each current version of a product (e.g., vCenter, NSX-T manager, or the like). FIG. 3 illustrates process objects including upgrade recommendation service 302, data structure 304, and an external webserver 306 (e.g., vendor's website) along with their respective vertical lines originating from them. The vertical lines of upgrade recommendation service 302, data structure 304, and external webserver 306 may represent the processes that may exist simultaneously. The horizontal arrows (e.g., 310, 312, 314, 316, 318, 320, and 326) may represent the data flow steps between the vertical lines originating from their respective process objects (for e.g., upgrade recommendation service 302, data structure 304, and external webserver 306). Further, activation boxes (e.g., 308, 322, and 324) between the horizontal arrows may represent the process that is being performed in the respective process object.

At 308, a scheduled cron job may be executed at defined intervals (e.g., periodic intervals such as every day at 8 AM). At 310, upgrade recommendation service 302 may transmit a first HTTP get command to webserver 306 to obtain available candidate upgrade versions. At 312, upgrade recommendation service 302 may receive a first response to the first HTTP get command from the webserver. The first response may include the list of candidate upgrade versions (e.g., 4.0.1.0.0 and 4.1.0.0.0).

For each candidate upgrade version in the list of candidate upgrade versions, upgrade recommendation service 302 may transmit a second HTTP get command to the webserver to obtain an URL for each candidate upgrade version, at 314. At 316, upgrade recommendation service 302 may receive a second response to the second HTTP get command. The second response may include the URL associated with a compatibility matrix of a candidate upgrade version. For example, upgrade recommendation service 302 may receive a first URL for candidate upgrade version 4.0.1.0.0 and a second URL for candidate upgrade version 4.1.0.0.0.

At 318, upgrade recommendation service 302 may transmit a third HTTP get command to the webserver to download compatibility matrix files corresponding to URLs. At 320, upgrade recommendation service 302 may download a compatibility matrix file associated with each candidate upgrade version based on the URLs. For example, upgrade recommendation service 302 may download a first compatibility matrix file corresponding to the first URL and a second compatibility matrix file corresponding to the second URL.

At 322, upgrade recommendation service 302 may extract compatibility matrix associated with each candidate upgrade version from the downloaded compatibility matrix files. For example, upgrade recommendation service 302 may extract a first compatibility matrix associated with candidate upgrade version 4.0.1.0.0 from the first compatibility matrix file and extract a second compatibility matrix associated with candidate upgrade version 4.1.0.0.0 from the second compatibility matrix file.

At 324, upgrade recommendation service 302 may determine a list of current versions that are compatible with each candidate upgrade version based on the extracted compatibility matrices. For example, upgrade recommendation service 302 may determine current versions 3.0.0.0.0, 3.1.0.0.0, and 3.2.0.0.0 as being compatible with candidate upgrade version 4.0.1.0.0 based on the first compatibility matrix. Further, upgrade recommendation service 302 may determine current versions 3.0.0.0.0, 3.1.0.0.0, 3.2.0.0.0, and 4.0.1.0.0 as being compatible with candidate upgrade version 4.1.0.0.0 based on the second compatibility matrix.

At 326, upgrade recommendation service 302 may populate data structure 304 with the list of candidate upgrade versions (e.g., 4.0.1.0.0 and 4.1.0.0.0) and the determined list of current versions (e.g., 3.0.0.0.0, 3.1.0.0.0, 3.2.0.0.0, and 4.0.1.0.0) that are compatible with the candidate upgrade versions.

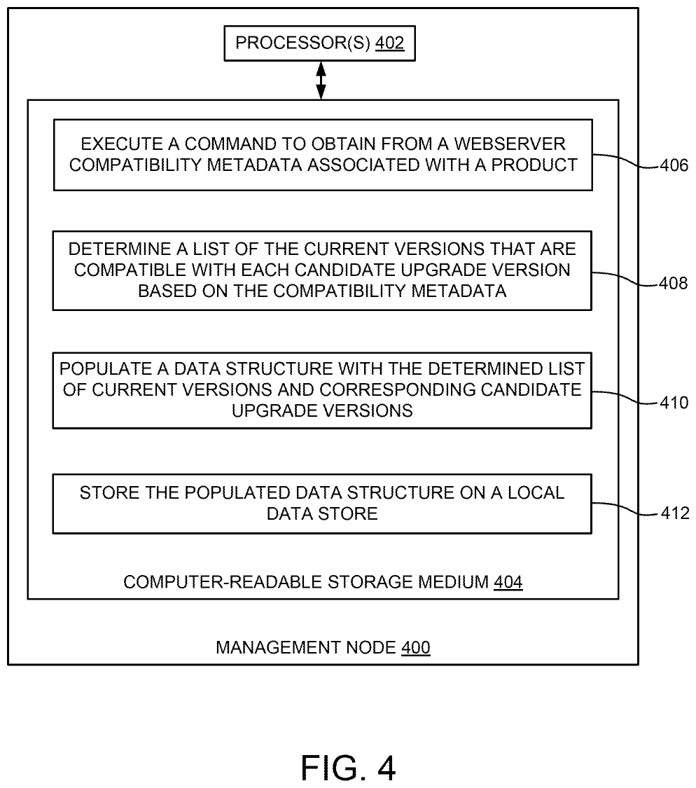

FIG. 4 is a block diagram of an example management node 400 including non-transitory computer-readable storage medium 404 storing instructions to populate a data structure indicating a list of candidate upgrade versions that are compatible with each current version of a product. Management node 400 may include a processor 402 and computer-readable storage medium 404 communicatively coupled through a system bus. Processor 402 may be any type of central processing unit (CPU), microprocessor, or processing logic that interprets and executes computer-readable instructions stored in computer-readable storage medium 404. Computer-readable storage medium 404 may be a random-access memory (RAM) or another type of dynamic storage device that may store information and computer-readable instructions that may be executed by processor 402. For example, computer-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 404 may be a non-transitory computer-readable medium. In an example, computer-readable storage medium 404 may be remote but accessible to management node 400.

Computer-readable storage medium 404 may store instructions 406, 408, 410, and 412. Instructions 406 may be executed by processor 402 to execute a command, at a first instance, to obtain compatibility metadata associated with a product from a webserver. The compatibility metadata may include a plurality of upgrade compatibility matrices corresponding to a plurality of candidate upgrade versions. Each upgrade compatibility matrix may provide information of current versions from which the product can be upgraded to one of the plurality of candidate upgrade versions. Instructions 406 to execute the command may include instructions to execute a cron job to obtain the compatibility metadata associated with the product from the webserver.

In an example, instructions 406 to execute the command may include instructions to execute the command to:
transmit a first hypertext transfer protocol (HTTP) get command to the webserver,
receive a first response to the first HTTP get command from the webserver, the first response including the list of candidate upgrade versions, and
for each candidate upgrade version in the list of candidate upgrade versions:
   transmit a second HTTP get command to the webserver, and
   receive a second response to the second HTTP get command, the second response including a uniform resource locator (URL) of a compatibility matrix, and
   download the compatibility matrix corresponding to the URL.

Instructions 408 may be executed by processor 402 to determine a list of the current versions that are compatible with each candidate upgrade version based on the compatibility metadata. Instructions 410 may be executed by processor 402 to populate a data structure with the determined list of current versions and corresponding candidate upgrade versions. The populated data structure may indicate a list of candidate upgrade versions that are compatible with each current version of the product.

Instructions 412 may be executed by processor 402 to store the populated data structure on a local datastore. Further, computer-readable storage medium 404 may include instructions to receive an upgrade request to upgrade the product running in a client device. The upgrade request may indicate a current version of the product. In response to receiving the upgrade request, computer-readable storage medium 404 may include instructions to retrieve a list of candidate upgrade versions that are compatible with the current version of the product from the stored data structure. Further, computer-readable storage medium 404 may include instructions to render the list of candidate upgrade versions that are compatible with the current version of the product on a user interface of the client device.

In response to a selection of a candidate upgrade version in the list of candidate upgrade versions, computer-readable storage medium 404 may include instructions to download an upgrade package associated with the selected candidate upgrade version from the webserver and upgrade the product based on the upgrade package.

Furthermore, computer-readable storage medium 404 may include instructions to execute the command, at a second instance, to obtain second compatibility metadata associated with the product from the webserver. Computer-readable storage medium 404 may include instructions to analyze the second compatibility metadata to detect a change in at least one of the plurality of upgrade compatibility matrices. In response to detecting the change in the at least one of the plurality of upgrade compatibility matrices, computer-readable storage medium 404 may include instructions to update the populated data structure in the local datastore based on the detected change.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method comprising:
obtaining from a webserver, at a first instance, first compatibility metadata associated with a product, wherein the compatibility metadata includes an indication of compatibility or incompatibility between a plurality of versions associated with the product in a first format;
transforming, using a data structure, the compatibility metadata from the first format to a second format, the second format indicating a list of candidate upgrade versions that are compatible with a current version of the product;
storing the transformed compatibility metadata on a local datastore; and
rendering the stored compatibility metadata including the list of candidate upgrade versions that are compatible with the current version of the product on a user interface of a client device in response to receiving an upgrade request.

2. The method of claim 1, further comprising:
in response to a selection of a candidate upgrade version in the list of candidate upgrade versions, downloading from the webserver an upgrade package associated with the candidate upgrade version; and
upgrading the product based on the upgrade package.

3. The method of claim 1, further comprising:
executing a cron job to obtain from the webserver the compatibility metadata associated with the product.

4. The method of claim 1, wherein the first format comprises:
data indicating mapping of a candidate upgrade version with a list of current versions from which the product can be upgraded to the candidate upgrade version.

5. The method of claim 1, wherein the second format comprises:
data indicating mapping of the current version with a list of candidate upgrade versions to which the product can be upgraded from the current version.

6. The method of claim 1, further comprising:
obtaining from the webserver, at a second instance, second compatibility metadata associated with the product;
analyzing the second compatibility metadata to detect a change in the second compatibility metadata compared to the first compatibility metadata; and
in response to detecting the change in the second compatibility metadata, updating the transformed compatibility metadata in the local datastore based on the detected change.

7. The method of claim 1, wherein obtaining the first compatibility metadata associated with the product comprises:
executing a scheduled command to:
transmit a first hypertext transfer protocol (HTTP) get command to the webserver;
receive from the webserver a first response to the first HTTP get command, the first response including the list of candidate upgrade versions; and
for each candidate upgrade version in the list of candidate upgrade versions:
transmit a second HTTP get command to the webserver; and
receive a second response to the second HTTP get command, the second response including the first compatibility metadata associated with the product.

8. A non-transitory computer-readable storage medium comprising instructions executable by a processor of a management node to:
execute a command, at a first instance, to obtain compatibility metadata associated with a product from a webserver, the compatibility metadata including a plurality of upgrade compatibility matrices corresponding to a plurality of candidate upgrade versions, wherein each upgrade compatibility matrix is to provide information of current versions from which the product can be upgraded to one of the plurality of candidate upgrade versions;
determine a list of the current versions that are compatible with each candidate upgrade version based on the compatibility metadata;
populate a data structure with the determined list of current versions and corresponding candidate upgrade versions, the populated data structure indicating a list of candidate upgrade versions that are compatible with each current version of the product; and
store the populated data structure on a local datastore.

9. The non-transitory computer-readable storage medium of claim 8, further comprising instructions to:
receive an upgrade request to upgrade the product running in an application host, the upgrade request indicating a current version of the product;
in response to receiving the upgrade request, retrieve a list of candidate upgrade versions that are compatible with the current version of the product from the stored data structure; and
render the list of candidate upgrade versions that are compatible with the current version of the product on a user interface of a client device.

10. The non-transitory computer-readable storage medium of claim 9, further comprising instructions to:
in response to a selection of a candidate upgrade version in the list of candidate upgrade versions, download from the webserver an upgrade package associated with the selected candidate upgrade version; and
upgrade the product based on the upgrade package.

11. The non-transitory computer-readable storage medium of claim 8, wherein instructions to execute the command comprise instructions to:
execute a cron job to obtain from the webserver the compatibility metadata associated with the product.

12. The non-transitory computer-readable storage medium of claim 8, wherein instructions to execute the command comprise instructions to:
execute the command to:
transmit a first hypertext transfer protocol (HTTP) get command to the webserver;
receive a first response to the first HTTP get command from the webserver, the first response including the list of candidate upgrade versions; and
for each candidate upgrade version in the list of candidate upgrade versions:
transmit a second HTTP get command to the webserver;
receive a second response to the second HTTP get command, the second response including a uniform resource locator (URL) of a compatibility matrix; and
download the compatibility matrix corresponding to the URL.

13. The non-transitory computer-readable storage medium of claim 8, further comprising instructions to:
execute the command, at a second instance, to obtain from the webserver second compatibility metadata associated with the product;
analyze the second compatibility metadata to detect a change in at least one of the plurality of upgrade compatibility matrices; and
in response to detecting the change in the at least one of the plurality of upgrade compatibility matrices, update the populated data structure in the local datastore based on the detected change.

14. A management node comprising:
a processor; and
a memory coupled to the processor, wherein the memory comprises an upgrade recommendation module to:
execute a command, at a first instance, to obtain first compatibility metadata associated with a product from a webserver, wherein the first compatibility metadata provides information indicating a list of current versions that are compatible with each candidate upgrade version of a plurality of candidate upgrade versions of the product;
parse the first compatibility metadata to determine a list of versions from which the product can be upgraded to each candidate upgrade version;
populate a data structure with the parsed first compatibility metadata, wherein the populated data structure is to indicate a list of candidate upgrade versions that are compatible with each current version of the product; and
in response to receiving an upgrade request, render the populated data structure on a user interface of a client device.

15. The management node of claim 14, wherein the upgrade recommendation module is to:
execute the command to:
transmit a hypertext transfer protocol (HTTP) get command to the webserver; and
receive a response to the HTTP get command from the webserver, the response including the first compatibility metadata.

16. The management node of claim 14, wherein the upgrade recommendation module is to:
receive a selection of a candidate upgrade version in the list of candidate upgrade versions via the user interface;
in response to receiving the selection, download from the webserver an upgrade package associated with the candidate upgrade version; and
upgrade the product based on the upgrade package.

17. The management node of claim 14, wherein the upgrade recommendation module is to:
obtain from the webserver, at a second instance, second compatibility metadata associated with the product;
analyze the second compatibility metadata to detect a change in the second compatibility metadata compared to the first compatibility metadata; and
in response to detecting the change in the second compatibility metadata, update the populated data structure in a local datastore based on the detected change.

18. The management node of claim 14, wherein the upgrade recommendation module is to:
receive an upgrade request to upgrade the product running in an application host, the upgrade request indicating a current version of the product;
in response to receiving the upgrade request, retrieve a list of candidate upgrade versions that are compatible with the current version of the product from the populated data structure; and
render the list of candidate upgrade versions that are compatible with the current version of the product on the user interface of a client device.

19. The management node of claim 14, wherein the upgrade recommendation module is to:
execute the command to:
transmit a first hypertext transfer protocol (HTTP) get command to the webserver;
receive a first response to the first HTTP get command from the webserver, the first response including the list of candidate upgrade versions; and
for each candidate upgrade version in the list of candidate upgrade versions:
transmit a second HTTP get command to the webserver;
receive a second response to the second HTTP get command, the second response including a uniform resource locator (URL) associated with a compatibility matrix of a candidate upgrade version; and
download the compatibility matrix associated with the candidate upgrade version corresponding to the URL.

20. The management node of claim 14, wherein the first compatibility metadata comprises a plurality of upgrade compatibility matrices corresponding to a plurality of candidate upgrade versions, wherein each upgrade compatibility matrix is to provide information of versions from which the product can be upgraded to a particular candidate upgrade version of the plurality of candidate upgrade versions.
